(19) United States
(12) Patent Application Publication
(10) Pub. No.: US 2015/0149355 A1
(43) Pub. Date: May 28, 2015

(54) SYSTEM AND METHOD FOR STAGING VOUCHER TRANSFERS

(71) Applicant: MoneyGram International, Inc., Dallas, TX (US)

(72) Inventors: Nittaya Arnthong, Frankfurt am Main (DE); Baran Caglayan, Russelsheim (DE); Daniela Primerano, Leverkusen (DE); Michael E. Hermansen, Shorewood, MN (US)

(73) Assignee: MoneyGram International, Inc., Dallas, TX (US)

(21) Appl. No.: 14/087,171

(22) Filed: Nov. 22, 2013

(51) Int. Cl. G06Q 20/10; G06Q 20/40

(52) U.S. Cl. CPC G06Q 20/10; G06Q 20/40
USPC 705/44

(57) ABSTRACT

Various embodiments concern methods of operating a server to facilitate transfer of a voucher to a receiver. Such methods include receiving a request at a server from a sender, the request indicating an identity of a receiver and a value designation, and receiving a selection of one or more vendors at the server. The methods further include sending a reference number to the sender from the server and receiving the reference number at the server from the receiver. The reference number is communicated from the sender to the receiver independently of the server. The methods further include authorizing release of a voucher to the receiver based on the reception of the reference number at the server and authentication of the identity of the receiver, the voucher redeemable only for goods and services with the selected one or more vendors.

### TECHNICAL FIELD

The present invention relates to methods and computer systems that facilitate voucher transfers. More particularly, the present invention is a method for operating a computer system that facilitates a sender paying for a voucher, and the voucher being provided to a receiver.

### BACKGROUND

A number of businesses offer money transfer and other services through a network of agents. A customer (i.e. a sender) that desires to use these services to transfer money to a third party (i.e. a receiver) can take the money to an agent of the money transfer service. The agent accepts the money, obtains necessary information such as the customer's identity and the identity of the receiver, and initiates a transfer. The money is then made available to the receiver by another agent. The receiver can then pick up the money. In these and other conventional transfers, the sender sets the amount of money to be transferred but otherwise has little or no control over how the money is spent by the receiver. The sender and receiver may negotiate a purpose for the money, such as the purchase of groceries, of which the sender approves, but the receiver may instead spend the money on non-food items after the transfer is complete. Senders may be more comfortable sending money if the sender can have greater assurance that the receiver will use the money for the sender's intended purpose. Therefore, there exists a need for a sender to be able to exert greater control over the use of transferred funds.

### SUMMARY

Various embodiments concern a server for facilitating the transfer of a voucher involving a sender associated with a first computer and a receiver associated with a second computer. The server is configured to receive a request sent from the first computer by the sender, the request indicating an identity of the receiver and a value designation, and receive a selection of one or more vendors from either the first computer or the second computer. The server is further configured to send a reference number to the sender by sending the reference number to the first computer, and then receive the reference number from the receiver via the second computer. The server is further configured to authorize release of a voucher to the receiver based on the reception of the reference number and on authentication of the identity of the receiver. The voucher is only redeemable for one or both of goods and services with the one or more vendors that were selected for the value designation. The server can be configured to generate a listing of vendors based on location and/or category criteria. The sender and/or receiver can review the category criteria to narrow down and/or select from the listing of vendors to arrive at the selected one or more vendors with which the voucher will be redeemable. The voucher may have an equivalent money value but the value may be locked in the voucher such that the voucher cannot be redeemed for money with the vendor, the facilitator of the transfer, or other entity. The first computer can be operated by the sender or by a send agent. The second computer can be operated by the receiver or by a receive agent.

Various embodiments concern methods for operating a server to facilitate the transfer of a voucher to a receiver. Such methods comprise receiving a request at a server from a sender, the request indicating the identity of the receiver and a value designation, and receiving a selection of one or more vendors at the server. The methods further comprise sending a reference number to the sender from the server and then receiving the reference number back at the server from the receiver. The method further comprises authorizing release of a voucher to the receiver, the voucher only redeemable for one or both of goods and services with the one or more vendors that were selected, the voucher redeemable for an amount corresponding to the value designation, the release authorized by the server based on the reception of the reference number at the server.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system for facilitating the sending of a voucher.

FIG. 2 is a flowchart of a method for facilitating the sending of a voucher.

FIG. 3 is a flowchart of a method for filtering vendors based on location criteria.

FIG. 4 is schematic view of vendors distributed in a geographic area.

FIG. 5 is a flowchart of a method for filtering vendors based on category criteria.

FIG. 6 is a flowchart of another method for facilitating the sending of a voucher.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

As discussed previously, a sender may lack control over the use of funds sent to a receiver through a conventional money transfer server. Embodiments of the present disclosure concern methods and computer systems for sending a voucher to a receiver. A voucher, as an alternative to cash, has inherent limitations in the manner in which it can be redeemed. Typically, a voucher is redeemable only with one or a few vendors. For example, a voucher may only be redeemable for goods and/or services with a single vendor (e.g., a single store of a business or multiple stores of a business chain). The vendor(s) may be known to only market particular types of goods or services. As such, a voucher redeemable only with a particular vender means that the receiver of the voucher is limited to using the voucher to receive those goods or services known to be available with the particular vendor.

As an example, a sender may desire to send money to a receiver, but the sender may be concerned with how the money will be spent by the receiver. The sender may only want the receiver to spend the money on food. The sender may accordingly arrange to have a voucher for food provided to the receiver, the voucher redeemable only at a grocery store. However, the sender and receiver may be in geographically different areas, making it difficult for the sender to purchase the voucher for the receiver and/or give the voucher to the receiver. The sender may be unfamiliar with what grocery store options exist in proximity to the receiver. In some cases, the sender may not want to limit the vendor choices of the receiver but may still want to limit the type of goods or services for which the voucher can be redeemed. Therefore, aspects of the present disclosure concern generating a listing of vendors based on a location of the receiver, category of goods or services, or other criteria, and facilitating selection of one or more vendors from the listing. Other features are also discussed herein.

The term voucher, as used herein, refers to a non-cash indicator of entitlement to goods and/or services with a vendor. The voucher can be physically embodied object, such as in a magnetically coded plastic card or a piece of paper. A voucher may take the form of a gift certificate (e.g., a gift card). The voucher may be stored and accessed electronically. In such case, the voucher may or may not be physically embodied. A voucher could accordingly be a virtual gift certificate that is not physically retained by the receiver but can be redeemed by providing a code associated with the voucher to a vendor. The term vendor, as used herein, refers to a business entity that markets goods and/or services. A single vendor or one vendor refers to a single business entity. A business entity may operate a single store location or multiple store locations and/or may operate an online store accessible via the internet. A plurality of vendors refers to multiple business entities. A sender, as used herein, refers to a person desiring to transfer something of value to a receiver. A receiver, as used herein, refers to a person whom the sender intends to receive the something of value. Criteria, as used herein, can be either singular or plural unless the context of a particular usage clearly indicates a singular or plural interpretation.

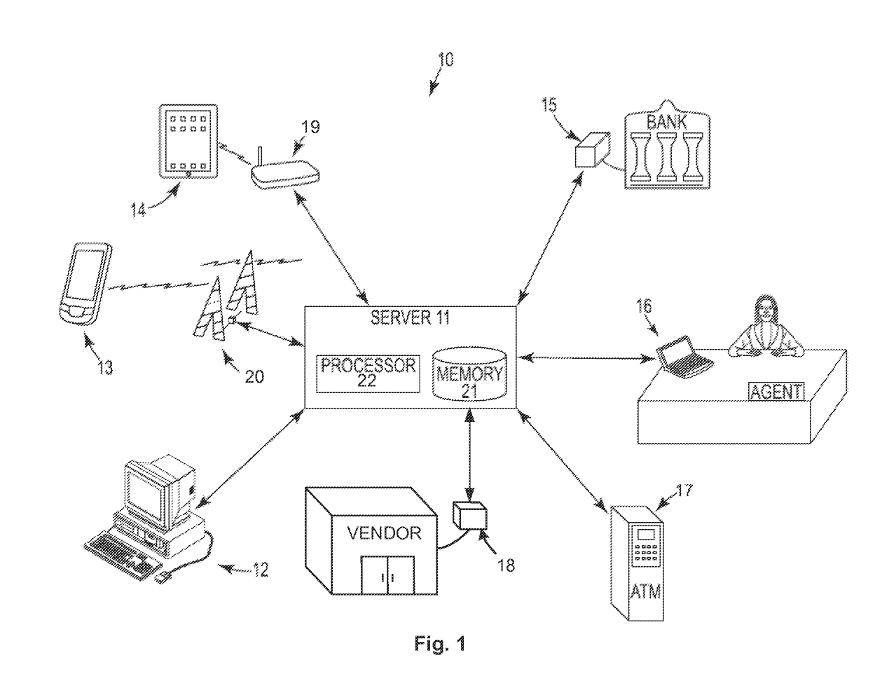

FIG. 1 illustrates a computer network across which users can setup transfers, including the sending of vouchers. As shown, the computer network can include a server 11 and a plurality of computing devices 12-18. The plurality of computing devices 12-18 can communicate with the server 11 through one or more computer protocols (e.g., TCP/IP) across one or more types of networks, such as cellular networks, local area networks, wide area networks, public networks, private networks, and other networks. Each of the plurality of computing devices 12-18 can be used by one or more users to communicate with the server 11. For example, a first user can use the interface of the personal computer 12 to communicate with the server 11. The personal computer 12 and/or any of other computing devices may include a browser or other application that provides an interface for the user to communicate with the server 11. A second user can use the cellular telephone 13 (e.g., a multifunctional smart phone) to communicate with the server 11 via a cellular network 20. A third user can use the tablet computer 14 to communicate with the server 11 via a wireless router 19. The server 11 can communicate with a proprietary network 15 of a bank independent of the financial service provider that operates the server 11. A fourth user can interface with an agent of the bank to facilitate transfers through the server 11.

An agent's computer 16 may be located at a facility that is approved by a financial services organization to facilitate money transfers and/or the sending of vouchers. For example, the agent's computer 16 may be located at a store or dedicated location that provides redemption services for money transfers. The agent's computer 16 may be operated by an agent at the approved send/receive location. The agent's computer 16 can communicate with the server 11, and a fifth user can interface with the agent. It will be understood that the agent's computer 16 represents the possibility of numerous agents at different locations with respective computers for communicating with the server 11 for facilitating transfers. For a transaction involving an agent, the agent interfaces with the sender or receiver to facilitate the transaction. For a transaction involving two agents, a first agent interfaces with the sender and a second agent interfaces with the receiver. Each agent can be a send or receive agent depending on which side of the transaction the agent is facilitating. A sixth user can use the automatic teller machine 17 (or similar type of automated banking interface) to communicate with the server 11. It will be understood that a variety of other computing devices can electronically communicate with the server 11 in accordance with the various embodiments of the present disclosure.

Vendor server 18 also communicates with the server 11. The vendor server 18 can communicate with the server 11 in any manner referenced herein or otherwise known. The vendor server 18 is associated with one or more vendors and can process and store data concerning vouchers and codes as further discussed herein. It will be understood that the vendor server 18 represents the possibility of numerous servers at different locations respectively associated with different vendors. Each vendor server 18 can be a proprietary server of the vendor with which it is associated for managing transactions with the vendor.

The server 11 communicates with the plurality of computing devices 12-18 by sending and receiving commands, requests, information, notifications, data, and the like over one or more communication networks. The server 11 operates a transfer service (e.g., a money transfer server in addition to a voucher transfer service). The server 11 may also deduct any commissions or fees associated with the transfers from the funds provided by the senders. These and other aspects are further discussed herein.

The server 11 may be housed and/or operated by or on behalf of the financial services organization that, among other functions, approves and coordinates the staging of transfers, communicates with the plurality of computing devices 12-18, and facilitates delivery of vouchers to receivers in the staged transfers. The financial service organization accepts money from the sender and in turn delivers a voucher to the receiver. In some embodiments, the server 11 is configured to automatically process staged transfers from the sender. In other embodiments, the server 11 provides information to a user at the financial services organization for review and approval. For example, the server 11 may be connected to a computer that provides an interface to a user at the financial services organization to review and approve or deny communications associated with the staging of money transfers. In some embodiments, the server 11 provides compliance functions for the staged money transfers.

The server 11 can include one or more processors 22 and one or more data structures 21 (e.g., volatile/non-volatile memory, hard disk drives, etc.). The data structures 21 can be used to store any information referenced herein. The processor 22 can execute program instructions stored in the data structures to perform any of the functions described herein. It will be understood that server 11, or a server as otherwise referenced herein, can include a plurality of networked computing devices that manage a proprietary platform, and is not necessarily limited to a single computing device with a processor 22 and data structure 21 as represented herein for convenience.

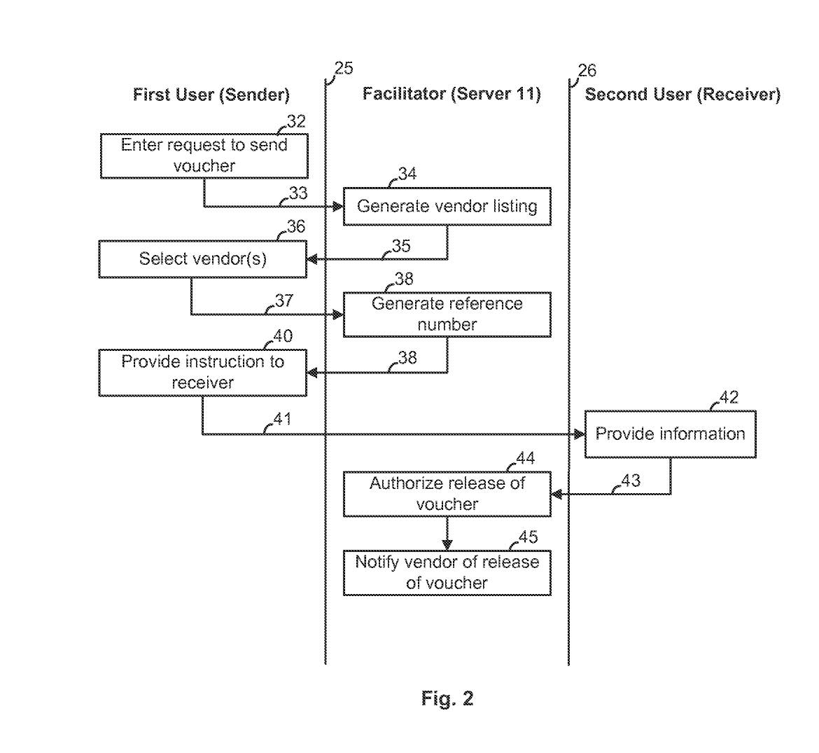

FIG. 2 illustrates a flowchart of communications sent between a computing device of a facilitator and the computing devices of first and second users. The facilitator is a financial service organization which provides a transfer server and the computing device of the facilitator is the server 11. The first user is a sender and the second user is a receiver in this case. It will be understood that the sender and/or receiver can directly use respective computing devices (e.g., a personal computer 12) or can indirectly use respective computing devices (e.g., the agent's computer 16) by interfacing with an agent to communicate with the facilitator. It will be understood that when the server 11 sends information to the sender or receiver, or receives information from the sender or receiver, as further described herein, the server 11 sends or receives the information in the form of data communicated through a data network with respect to a computer operated by the sender or receiver or operated on behalf of the sender or receiver.

The flowchart of FIG. 2 includes a first user column (left of the first boundary 25), a facilitator column (between the first boundary 25 and the second boundary 26), and a second user column (right of the second boundary 26). The first user column represents steps performed by a computing device being used, directly or indirectly, by the first user. The facilitator column represents steps performed by the server 11. The second user column represents steps performed by a computing device being used, directly or indirectly, by the second user. It is noted that the steps within each of the columns can be performed by multiple computing devices. For example, the first user may use a first computing device for some of the steps and a second computing device for later steps. Each of the first boundary 25 and the second boundary 26 can represent transmission of information over one or more networks between the computing devices. For example, the first boundary 25 can represent electronic communication between the computing device used by the first user and the server 11 while the second boundary 26 can represent electronic communication between the computing device used by the second user and the server 11.

The method of FIG. 2 includes the sender entering 32 a request to send a voucher. The sender can enter 32 the request into one of the computing devices 12-14. Alternatively, the sender can have the request entered 32 by an agent at an agent location into the agent's computer 16. The request can include a value designation, the identity of the receiver, an indication that the sender wants to send a voucher to the receiver (e.g., instead of a money transfer) and/or any other information referenced herein. The request can also include criteria for vendor locations or categories as further discussed herein. The value designation can be the amount of money for which the voucher will be redeemable. The identity of the receiver can include the name of the receiver. The criteria can take various forms. For example, criteria can be location criteria or category criteria. Location criteria can be the home address of the receiver, the town or city in which the receiver lives, the county in which the receiver lives, the geographic region in which the receiver lives, the state in which the receiver lives, and/or the country in which the receiver lives. In some cases, the location criteria may not specify a location in which the receiver lives but rather indicates a location (e.g., address, city, state, region, country, etc.) in which the sender knows the receiver can access. In some cases, the location criteria may include a specified range, such that the sender indicates a location and a range (e.g., an address and a 10 mile radius around the address). Other location criteria is within the scope of this disclosure. For example, the location criteria can include information specifying a specific location or general area within which the sender wants to exclusively limit use of the voucher. Category criteria refers to a type of good or service offered by the vendor. For example, category criteria can include food, gas, clothes, mechanic work, or medical services, for example. Other aspects of category criteria are further discussed herein.

The request information, including any specific information referenced herein such as receiver identity, value designation, and criteria, is sent 33 by the computing device and received by the server 11. It is noted that the request information may be sent 33 and received as a single transmission or may be sent as a series of transmissions over time (e.g., the receiver identity may be sent separately from the location criteria).

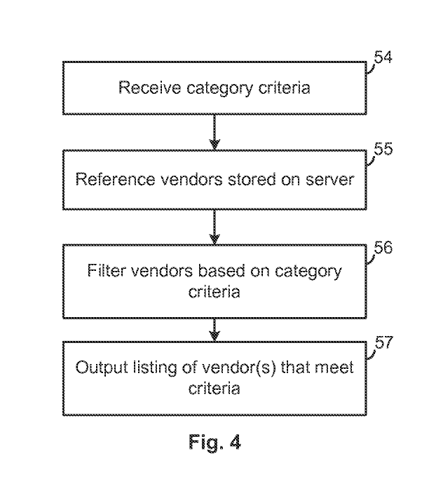

The server 11 generates 34 a listing of vendors based on the request. Specifically, the server 11 references a database of all vendors with which the facilitator has a business relationship for issuing vouchers and then filters the vendors based on whether the vendors satisfy the specified criteria. The listing of vendors will typically include a plurality of different vendors. Generating 34 the listing of vendors can include creating a list of all vendors having store locations within a predetermined range (e.g., five miles) of the specified location of the receiver or within a specified geographic area. In the case of category criteria, generating 34 the listing of vendors can include creating a list of all vendors that market the specified good or service. In some cases, multiple criteria can be specified, such as location and category criterion. Filtering of vendors based on criteria is further discussed herein in connection with FIG. 4.

Once generated 34, the listing of vendors is then sent 35 by the server 11 and received by the sender. The sender can then review the listing of vendors. For example, the listing of vendors can be displayed on a screen of the computing device associated with the sender or told to the sender by an agent. In connection with reviewing the listing of vendors, the sender can select 36 one or more vendors from the listing of vendors. The selection 36 of the one or more vendors corresponds with which vendor(s) the sender intends the voucher to be redeemable for goods and/or services. In some cases, a single vendor is selected 36. In some other cases, multiple vendors may be selected 36 in anticipation of the receiver further narrowing the group to a single vendor or the voucher being redeemable at multiple vendors. The selection 36 is then sent 36 by the computing device associated with the receiver and received by the server 11.

It is noted that the sender provides payment to the facilitator to fund the voucher. The sender may optionally provide a commission fee to the facilitator. The payment can be provided to the facilitator upon entering 32 of the request, upon selection 36 of the vendor(s), or with another step. If the receiver is interacting with the facilitator through a web browser running on a computing device or on another application running on the computing device, then the payment may be made by use of a credit card, bank account, or other account belonging to the sender. As another example, if the receiver is interacting with a send agent, then payment may be made with a check, credit card, cash, bank account, or other account belonging to the sender to the send agent.

Once the facilitator has the necessary information to stage the transaction (e.g., payment, identity of receiver, and vendor selection 36), then the server 11 can stage the transaction. Staging the transaction can include finalizing the terms of the transaction and returning instructions to the sender on how the receiver is to complete the transaction.

The server 11 generates 38 a reference number. A reference number, as used herein, is a code, usually a series of numbers and/or letters, that allows the receiver to reference the transaction. The reference number also serves as a layer of security because the voucher cannot be received by the receiver, or a purported receiver, without the receiver first providing the reference number to the facilitator. The reference number may not be sent to the receiver by the facilitator. Rather, as shown in FIG. 2, the reference number is sent 38 by the server 11 to a computer associated with the sender so that the sender receives the reference number. It is then up to the sender to communicate the reference number to the receiver. As such, the sender provides 40 instruction to the receiver. Such instruction can include the reference number and any other information necessary for completing the transfer. Such information may include where the receiver can go to interface with the facilitator (e.g., a particular agent location) or how the receiver is to interface with the facilitator (e.g., a web address of an internet portal of the facilitator). In some cases, the sender can provide 40 instruction to the receiver by sending 41 the instruction from a computer associated with the sender to a computer associated with the receiver, such as via email or text message. In some cases, the sender can have a telephone or in-person conversation with the receiver to communicate the instruction.

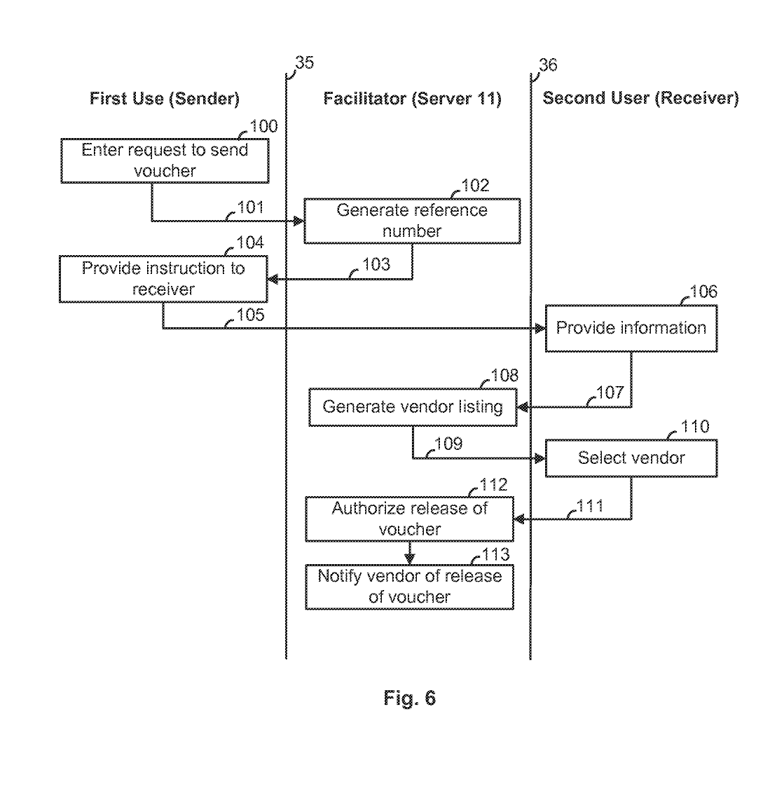

The method further includes the receiver, after receiving the instruction from the sender, providing 42 information to the facilitator. The provided 42 information will typically include the reference number. The provided 42 information will also typically include information that identifies the receiver. For example, the receiver may provide an identification card or other information which can authenticate that the person who is interacting with the facilitator corresponds to the identity of the receiver that the sender entered 32 as part of the request. It is noted that the method of FIG. 2 can be modified such that the receiver may also be presented with an opportunity to select the vendor for which the voucher is issued, and with which the voucher can be redeemed, the details of which are further discussed in connection with FIG. 6. For example, the sender may provide initial criteria which narrow the listing of vendors to a first set of vendors having multiple vendor options. The receiver may have to then limit the first set to a single vendor through selection from amongst the first set, for which the voucher will be issued and redeemable with the selected vendor. The provided 42 information is sent 43 by a computing device associated with the receiver and is received by the server 11.

The server 11 can authorize 44 release of the voucher to the receiver based on the server 11 receiving confirmation of the identity of the receiver and receiving the reference number from the receiver. In some cases, the server 11 automatically authorizes release of the voucher based on particular conditions being satisfied, such as receiving the confirmation number from the receiver and/or confirming the receiver's identity. Authorizing 44 release of the voucher can include sending a notification to an agent interacting with the receiver to give the receiver the voucher. Authorizing 44 release of the voucher can include sending an electronic copy of the voucher to the receiver to allow the receiver to print or otherwise access the voucher. For example, if the receiver is interfacing with the facilitator remotely via a computing device (e.g., by an internet portal operated by the facilitator), then the voucher could be sent via email, text message, or downloaded from a website operated by the facilitator (e.g., hosted on the server 11). In Authorizing 44 release of the voucher can include sending a code or certificate to the receiver that, when the receiver presents the code or certificate to the vendor (in-person at a store location or remotely over the internet) the vendor then gives or otherwise provides the voucher to the receiver.

Before, during, or after the server 11 authorizes release of the voucher or when the facilitator otherwise provides the voucher to the receiver, the server 11 notifies 45 the vendor of the release of the voucher. The notification 45 step may be necessary for activating the voucher to allow its use for redemption. For example, the facilitator may store a quantity of inactivated vouchers (e.g., as physical cards and/or electrically as codes) that cannot be redeemed with the vendor until the vendor authorizes the use of each voucher by receipt of a code associated with each voucher. As such, the notification 45 can include sending an electronic message to the vendor indicating a unique code associated with a particular voucher that indicates to the vendor which voucher to accept. The facilitator may also provide payment to the vendor for the voucher at the time of notifying 45 vendor or upon authorizing 44 the release of the voucher. In some other cases the facilitator may retain a quantity of pre-paid vouchers but may keep them inactivated for security reasons until each is individually provided to a receiver. In any case, the vendor may only allow redemption of each voucher with the vendor if the vendor has been notified 45 that the voucher has been provided to the receiver or otherwise issued.

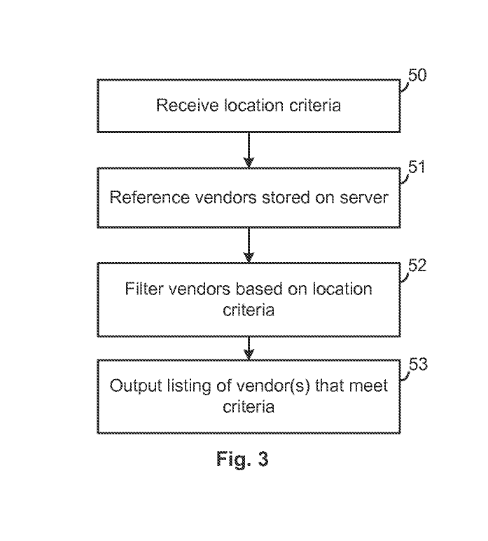

As demonstrated in the discussion of FIG. 2, the sender and the server 11 can identify one or more vendors with whom the voucher will be redeemable. Such a feature allows the sender to have some control over how the value sent to the receiver is used. However, the sender may not be familiar with the vendor options in receiver's area and/or may require a more convenient option than dealing directly with the vendor. As such, various embodiments can assist the sender in sorting through vendor information to find an appropriate vendor for which to send a voucher to the receiver. The method of FIG. 3 further details such a process.

The method of FIG. 3 can be performed by the facilitator. For example, the server 11 may automatically perform the steps of FIG. 3. The method of FIG. 3 includes receiving location criteria. Various location criteria has already been discussed herein, and may include such options as address, city, state, region, country or other geographic identification. The location criteria can further include a constraint term, such as a radius or boundary condition. For example, the location criteria can include an address or city while the constraint term can be a radius around the address or city. Alternatively, the constraint term may be a boundary such as the boundary of the city or other specified area.

Based on the received 50 location criteria, the method can then reference 51 information stored on the server 11 in association with each vendor for which the facilitator is able to offer vouchers. The server 11 may store information for all affiliated vendors worldwide, but such a quantity would be overwhelming for the sender. As such, the server 11 references 51 all vendors and then filters 52 the vendors based on the location criteria. Filtering 52 the vendors can include narrowing the vendors by only including those vendors in a set which satisfy the location criteria. Returning to the examples of the location criteria concerning a radius or bounded area, the filtering 52 of the vendors creates a list of only those vendors have a store located within the radius or bounded area. Once all vendors have been considered by the filtering 52 step, the server 11 can output a listing of vendors, each of the vendors in the listing satisfying the criteria. The listing of vendors can then be presented to the sender. If the number of vendors in the listing of vendors is overwhelming or the options of vendors from the listing of vendors are not sufficient, then the sender can modify or change the location criteria and repeat the method of FIG. 3. The radius or bounded area may be made larger or smaller by the sender to increase or decrease the number of vendors as preferred. The method of FIG. 3 can be repeated until the sender is satisfied with the vendor options.

While location criteria has been used as an example of an constraint for selecting a vendor, other criteria are additionally or alternatively possible. Such other criteria can include category criteria. Category criteria can refer to the type of goods and/or services offered, type of goods and/or services not offered (e.g., alcohol), type of store (e.g., online shopping or in-person shopping options), number of stores per vendor (e.g., single store or chain of stores), and/or hours of operation (e.g., open 24 hours per day or only open during standard business hours), among other options for differentiating the nature of business conducted by the vendors. Any such criteria can be sent to the server 11 by the sender and/or receiver. The server 11 can then generate 34 the listing of vendors based on a single criterion (e.g., location) or the server 11 can generate 34 the listing of vendors based on multiple criteria (e.g., location and type of goods sold).

FIG. 4 shows a method for generating a listing of vendors based on category criteria. The method of FIG. 4 can be performed by the facilitator. For example, the server 11 may automatically perform the steps of FIG. 4. The method of FIG. 4 includes receiving category criteria. Various category criteria options are possible. For example, the category criteria can specify the type of goods and/or services sold at the vendors. A sender may specify positive category criteria requiring the category of good or service to be offered by a vendor. A sender may specify a negative category criteria prohibiting the category of good or service from being offered in a vendor. Examples of category criteria include food generally, or specific types of food such as produce, meat, dairy, food ingredients, and prepared food, among other food goods. Other examples of category criteria include gasoline, clothes, furniture, office supplies, school supplies, and books, among other non-food goods. Category criteria can concern services such as medical professional services (e.g., hospital, doctor, dentist), mechanic services, and childcare, among other services. It is noted that multiple category criteria may be specified in the received 54 category criteria, and each category criteria may be specified to be positive (i.e. the vendor must offer such a good or service in order to satisfy the criteria) or negative (i.e. the vendor must not offer such a good or service in order to satisfy the criteria).

Based on the received 54 category criteria, the method can then reference 55 vendors stored on the server 11. The server 11 may store category information in association with the profile of each vendor on the server 11. For example, for each vendor for which the facilitator is able to offer a voucher, the server 11 may store possible category criteria for the vendor. The server 11 references 55 all vendors and then filters 56 the vendors based on the category criteria. Filtering 56 the vendors can include narrowing the vendors by only including those vendors in a set which satisfy the positive or negative category criteria. Once all vendors have been considered by the filtering 56 step, the server 11 can output a listing of vendors that satisfy the specified category criteria. The listing of vendors can then be presented to the sender. If the number of vendors in the listing of vendors is overwhelming or the options of vendors from the listing of vendors are not sufficient, then the sender can modify or change the category criteria and repeat the method of FIG. 4. The method of FIG. 4 can be repeated until the sender is satisfied with the vendor options.

While the methods of FIGS. 3 and 4 have been discussed in connection with the sender specifying criteria, it is noted that the methods of FIGS. 3 and 4 may be performed based on category criteria received 50, 54 from the receiver, and the listing of vendors may be output 53, 57 to the sender to select a vendor, as further discussed herein in connection with FIG. 6.

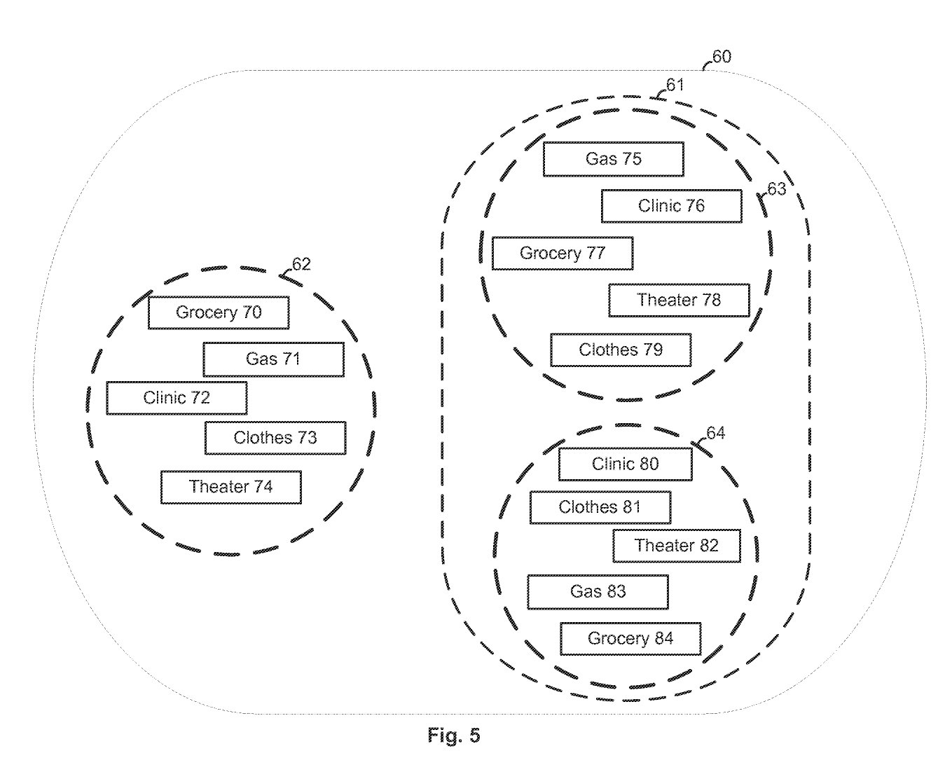

FIG. 5 illustrates a diagram of an example of filtering vendors based on criteria that can be specified by a sender or receiver. Each of a first area 60, a second area 61, a third area 62, a fourth area 63, and a fifth area 64 are outlined by respective boundaries. Each of the areas 60-64 can represent location criteria. For example, the third area 62 can represent a three mile radius around a central location. The second area 61 can represent the boundaries of a city. The first area 60 can present the boundaries of a county or state. All vendors 70-84 are within the first area 60, while only some vendors 75-84 are in the second area 61. Vendors 70-74 are not in the second area 61. Vendors 70-74 are within the third area 62 while vendors 75-84 are not within the third area 62. If location criteria specified the second area 61, then vendors 75-84 would satisfy that location criteria and would be included in a listing of vendors while vendors 70-74 would not satisfy the location criteria and would not be included in the listing of vendors.

The vendors 70-84 each also include category information indicating a type of good or service offered by the particular vendor. As previously discussed, vendors can be categorized based on the type of good or service offered. The category criteria can be used to narrow a database of vendors to a smaller listing of vendors. If the category criteria specified groceries, then vendors 70, 77, and 84 would be listed. However, if the location criteria listed the third area 62 and the category criteria specified groceries, then only vendor 70 would be listed. In some cases, a negative category criteria can be specified which filters out vendors which market a particular type of good or service. For example, a sender may provide the third area 62 as positive location criteria but may also list theater tickets as negative category criteria, such that the generated listing of vendors would include vendors 70-73 but would not include the theater vendor 74. It will be appreciated that many other permutations are possible depending on the criteria specified.

FIG. 6 illustrates a flowchart of communications sent between a computing device of a facilitator and the computing devices of first and second users. The flowchart can correspond to the method and steps of FIG. 2 except as otherwise specified. The method of FIG. 6 includes the sender entering 100 a request to send a voucher. The sender can enter 100 the request into one of the computing devices 12-14 directly. Alternatively, the sender can have the request entered 100 by a send agent at an agent location into the agent's computer 16. The request can include a value designation, the identity of the receiver, an indication that the sender wants to send a voucher to the receiver (e.g., instead of a money transfer) and/or any other information referenced herein. While the sender may include criteria, such as location or category criteria, in the request, such a feature or scenario is not shown in FIG. 6.

The request information, including any specific information referenced herein, is sent 101 by the computing device associated with the sender and received by the server 11. It is noted that the request information may be sent 101 and received as single transmission or may be sent as a series of transmissions over time.

The server 11 generates 102 a reference number. The reference number is sent 102 by the server 11 to a computer associated with the sender so that the sender receives the reference number. The sender provides 104 instruction to the receiver. Such instruction can include the reference number and/or other information to enable the receiver to receive the voucher.

The method further includes the receiver, after receiving the instruction from the sender, providing 106 information to the facilitator. The provided 106 information will typically include the reference number. The provided 106 information will also typically include information that identifies the receiver. For example, the receiver may provide an identification card or other information which can authenticate that the person who is interacting with the facilitator corresponds to the identity of the receiver that the sender entered 100 as part of the request. The receiver may also include criteria (e.g., location or category criteria) in the provided 106 information. It is noted that the provided 106 information may be sent 107 and received as single transmission or may be sent as a series of transmissions over time (e.g., the reference code is sent 107 separately with respect to the criteria).

Based on reception of the provided 106 information, the server generates 108 a listing of vendors. The generating 108 of the listing of vendors can be done in accordance with any method referenced herein (e.g., similarly to the generating 34 step discussed in connection with FIG. 2). If the sender has not already narrowed the possible vendors by specifying some limiting criteria (e.g., in a process similar to that of FIG. 2), then the server 11 references a database of all vendors with which the facilitator has a business relationship for issuing vouchers and then filters the vendors based on whether the vendors satisfy the category criteria. If the sender has already narrowed the possible vendors by specifying some limiting criteria, while still leaving some vendor options available, then the server 11 references a database of those remaining vendors and then filters the remaining vendors based on whether the vendors satisfy the receiver specified criteria. The listing of vendors is then sent 109 by the server 11 and received by the receiver. The receiver can then review the listing of vendors. For example, the listing of vendors can be received by a computing device associated with the receiver and then displayed on a screen of the computing device associated with the receiver or told to the receiver by an agent. In connection with reviewing the listing of vendors, the receiver can select 110 a vendor from the listing of vendors. The selection 110 of the vendors corresponds with which vendor the sender intends the voucher to be redeemable for goods and/or services. Typically, the selection 110 would be of only one vendor because, in most embodiments, the voucher is only redeemable with one vendor. However, multiple vendors may be selected 110 if the receiver is provided with choice of dividing the designated value between multiple vendors or if a single voucher is redeemable with multiple vendors. The selection 110 is then sent 111 by the computing device associated with the receiver and received by the server 11.

The server 11 can authorize 112 release of the voucher to the receiver based on the server 11 receiving the vendor selection 110, the identity confirmation for the receiver, and the reference number from the receiver. In some cases, the server 11 automatically authorizes release of the voucher based on particular criteria being satisfied, such as receiving the confirmation number, receiving the vendor selection 110, and/or confirming the receiver's identity. Authorizing 112 release of the voucher can be performed in any manner referenced herein including in a manner similar to the authorizing 44 step of the method of FIG. 2. The server 11 may notify 113 the vendor of the release of the voucher, which can be performed in any manner referenced herein including in a manner similar to the notifying 113 step of the method of FIG. 2.

A sender may use any of the methods discussed herein, or a modification of any such method, to send vouchers to multiple receivers. The sender may then specify the same or different vendor criteria for each of the receivers. It is also noted that any of the methods of this disclosure, or any modification of the same, can additionally or alternatively be used to setup a reoccurring voucher transfer that comprises a plurality of transfers (e.g., to a single receiver) to be performed at a plurality of different times according to a schedule. The voucher criteria may be the same for each transfer, or the voucher criteria may change as specified by the sender. The receiver may or may not be given the opportunity to select different vendors with each transferred voucher, depending on whether the sender has specified a vendor or left an opportunity of the receiver to make the final vendor selection.

While the embodiments discussed herein concern the issuing of a new voucher, each of the methods can be adapted to apply a greater redeemable value to a voucher that the receiver already has. For example, a receiver may already have a voucher (e.g., a gift certificate) that the receiver can use at a particular store. The methods of the present disclosure (e.g., any of the methods of FIGS. 2-4 and 6) can be employed to select the vendor that corresponds with the receiver's voucher and the designated value entered by the sender can be added to the redeemable value of the receiver's gift certificate. In this case, the sender can still exert control over how the funds are used because the receiver's gift certificate must still meet any specified vendor criteria provided by the sender before, as discussed above, because the funds would be authorized to be added to the receiver's voucher. The server 11 can then send a notification to the vendor informing the vendor of the increased redeemable value of the gift certificate.

It is noted that the voucher transfers referenced herein can relate to a voucher transfer, executed by a facilitator (e.g., operating a money transfer service), from a sender (e.g., as a first user) to a receiver (e.g., as a second user) without a bilateral exchange of value between, or on behalf of, the sender and the receiver. As such, the transfer from the sender to the receiver can be a unilateral exchange of value from the sender to the receiver without an exchange of money, goods, services, or other thing of value in return to the sender. A commission may be paid to the facilitator by either of the sender or the receiver for providing the voucher transfer service. The facilitator may additionally or alternatively make money on the transfers by agreeing with the vendors to not pay the full designated value for each voucher. As such, the facilitator may receive a discount on the voucher when buying the voucher from the vendor. As an example, the facilitator may purchase one or a group of vouchers from a particular vendor for 90% of the redeemable value of the vouchers. The sender pays the facilitator 100% of the redeemable value for the facilitator to transfer the voucher to the sender. In another sense, the facilitator pays a first amount to the vendor for the voucher and then, upon payment of a second amount to the facilitator by the sender, the facilitator transfers the voucher to the receiver, the voucher being redeemable with the vendor for a third amount, wherein the first amount is less than either of the second and third amounts, and the second amount is less than the third amount or the second amount is equal to the third amount.

In many cases, the sender is the client of the money transfer service and the receiver is a third party beneficiary. As such, the facilitator of the voucher transfer service will honor the preferences of the sender over the preferences of the receiver. However, the sender may not be particular about precisely at which vendor the voucher is redeemable as long as some criteria is met. For example, the sender may not be particular as to at which store the voucher is redeemable as along as the store is a grocery store. As such, the sender may specify a first set of criteria for generating 108 the listing of vendors (e.g., only grocery stores within a particular area) such that the receiver is given the opportunity to select a vendor that markets groceries within the area.

While the methods discussed herein have a first user, as a sender, initiating a voucher transfer, similar methods can be used wherein the receiver initiates the transfer. Such receiver initiated voucher transfers, or sender initiated transfers, can be conducted in view of U.S. patent application Ser. No. 13/957,186, filed on Aug. 1, 2013, which is incorporated herein by reference in this entirety.

The methods described in this disclosure, including those of FIGS. 1-6 and those attributed to a system, computing device, server, processor, and/or other type of control circuitry, or various constituent components, may be implemented wholly or at least in part, in hardware, software, firmware or any combination thereof. The functions referenced herein and those functions of FIGS. 1-6, may be embodied as firmware, hardware, software or any combination thereof as part of control circuitry specifically configured (e.g., with programming) to carry out those functions, such as in means for performing the functions referenced herein. The steps described herein may be performed by a single processing component or multiple processing components, the latter of which may be distributed amongst different coordinating devices. In this way, a server may be distributed between multiple devices, such as a coordinating network of devices. Depiction of different features is intended to highlight different functional aspects and does not necessarily imply that such features must be realized in separate embodiments or separate elements. Rather, functionality associated with one or more elements may be performed by separate hardware or software components, or integrated within common or separate hardware or software components of the system as control circuitry.

When implemented in software, the functionality ascribed to methods, systems, devices, and/or servers described in this disclosure may be embodied as instructions on a physically embodied computer-readable medium such as RAM, ROM, NVRAM, EEPROM, FLASH memory, magnetic data storage media, optical data storage media, or the like, the medium being physically embodied in that it is not a carrier wave, as part of control circuitry. The instructions may be executed by a processing component to support one or more aspects of the functionality described in this disclosure.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A method of operating a server to facilitate transfer of a voucher to a receiver, the method comprising:
receiving a request at a server from a sender, the request indicating an identity of a receiver and a value designation;
receiving a selection of one or more vendors at the server;
sending a reference number to the sender from the server;
receiving the reference number at the server from the receiver;
authorizing release of a voucher to the receiver, the voucher only redeemable for one or both of goods and services with the one or more vendors that were selected, the voucher redeemable for an amount corresponding to the value designation, the release authorized by the server based on the reception of the reference number at the server.

2. The method of claim 1, further comprising:
receiving location criteria from the sender at the server; and
generating a listing of vendors, the listing of vendors identifying at least one vendor, the listing of vendors generated at least in part by the server by comparing information stored on the server for a plurality of vendors to the location criteria and listing only those vendors that satisfy the location criteria.

3. The method of claim 2, further comprising sending the listing of vendors to the sender, wherein the selection of the one or more vendors is made by the sender and is received at the server from the sender.

4. The method of claim 2, further comprising sending the listing of vendors to the receiver, wherein the selection of the one or more vendors is made by the receiver and is received at the server from the receiver.

5. The method of claim 1, further comprising:
sending a listing of vendors to the sender;
receiving a selection of a plurality of vendors made by the sender from the listing of vendors, the selection of the plurality of vendors received at the server; and
sending the selection of the plurality of vendors to the receiver, wherein receiving the selection of the one or more vendors at the server comprises receiving selection of a single vendor from the plurality of vendors at the server from the receiver, and wherein the voucher is redeemable only with the single vendor.

6. The method of claim 1, further comprising:
receiving category criteria at the server from the sender, the category criteria specifying a type of good or service; and
generating a listing of vendors, the listing of vendors generated at least in part by the server by comparing information stored on the server for a plurality of vendors to the category criteria and listing only those vendors that satisfy the category criteria.

7. The method of claim 6, further comprising sending the listing of vendors to the sender, wherein receiving the selection of the one or more vendors at the server comprises receiving selection of a single vendor from the listing of vendors at the server from the sender, and wherein the voucher is redeemable only with the single vendor.

8. The method of claim 6, further comprising sending a listing of vendors to the receiver, wherein receiving the selection of the one or more vendors at the server comprises receiving selection of a single vendor from the listing of vendors at the server from the receiver, and wherein the voucher is redeemable only with the single vendor.

9. The method of claim 1, wherein:
a first computer is used by the sender or by a send agent to send the request that is received by the server,
the first computer receives the reference number that is sent from the server,
a second computer is used by the receiver or by a receive agent to send the reference number that is received by the server, and
either of the first computer or the second computer is used to send the selection of the one or more vendors that is received by the server.

10. The method of claim 1, further comprising receiving an indication that the receiver has been authenticated by a receive agent as the person who corresponds to the identity of the request, wherein the release of the voucher is only authorized by the server after the indication has been received by the server.

11. The method of claim 1, further comprising sending a notification from the server to a vendor server, the notification indicating that the voucher has been authorized for release, wherein the voucher is redeemable with the one or more vendors that were selected only after the vendor server receives the notification.

12. The method of claim 1, wherein the one or more vendors comprises only one vendor.

13. A server for facilitating transfer of a voucher to a receiver, the server configured to:
receive a request from a sender, the request indicating an identity of a receiver and a value designation;
receive a selection of one or more vendors;
send a reference number to the sender;
receive the reference number from the receiver; and
authorize release of a voucher to the receiver, the voucher only redeemable for one or both of goods and services with the one or more vendors that were selected, the voucher redeemable for an amount corresponding to the value designation, the release authorized based on the reception of the reference number.

14. The server of claim 13, wherein the server is further configured to:
receive location criteria from the sender; and
generate a listing of vendors, the listing of vendors identifying at least one vendor, the listing of vendors generated by comparing information stored on the server for a plurality of vendors to the location criteria and listing only those vendors that satisfy the location criteria.

15. The server of claim 14, wherein the server is further configured to send the listing of vendors to the sender, wherein the selection of the one or more vendors is made by the sender and is received at the server from the sender.

16. The server of claim 14, wherein the server is configured to send the listing of vendors to the receiver, and wherein the selection of the one or more vendors is made by the receiver and is received from the receiver.

17. The server of claim 13, wherein the server is configured to:
send a listing of vendors to the receiver;
receive a selection of a plurality of vendors made by the receiver from the listing of vendors;
send the selection of the plurality of vendors to the receiver; and
receive selection of a single vendor from the plurality of vendors from the receiver, and wherein the voucher is redeemable only with the single vendor.

18. The server of claim 13, wherein the server is configured to:
receive category criteria from the sender, the category criteria specifying a type of good or service; and
generate a listing of vendors, the listing of vendors generated by comparing information stored on the server for a plurality of vendors to the category criteria and listing only those vendors that satisfy the category criteria.

19. The server of claim 18, wherein the server is configured to send the listing of vendors to the sender, wherein reception of the selection of the one or more vendors at the server comprises receiving selection of a single vendor from the listing of vendors from the sender, and wherein the voucher is redeemable only with the single vendor.

20. The server of claim 18, wherein the server is configured to send the listing of vendors to the receiver, wherein reception of the selection of the one or more vendors at the server comprises receiving selection of a single vendor from the plurality of vendors from the receiver, and wherein the voucher is redeemable only with the single vendor.

21. The server of claim 13, wherein the server is configured to:
receive the request from the sender by receiving the request from a first computer used by the sender or by a send agent;
send the reference number to the sender by sending the reference number to the first computer;
receive the reference number from the receiver by receiving the reference number from a second computer used by the receiver or by a receiver agent; and
receive the selection of one or more vendors from either of the first computer or the second computer.

22. The server of claim 13, wherein the server is configured to receive an indication that the receiver has been authenticated by a receive agent as the person who corresponds to the identity of the request, wherein the server is configured to release the voucher only if the indication that the receiver has been authenticated has been received.

23. The server of claim 13, wherein the server is configured to send a notification to a vendor server, the notification indicating that the voucher has been authorized for release, wherein the voucher is redeemable with the one or more vendors that were selected only after the vendor server receives the notification.

24. The server of claim 13, wherein the one or more vendors comprises only one vendor.

25. A server for facilitating the transfer of a voucher involving a sender associated with a first computer and a receiver associated with a second computer, the server configured to:
receive a request sent from the first computer by the sender, the request indicating an identity of the receiver and a value designation;
receive a selection of one or more vendors from either the first computer or the second computer;
send a reference number to the sender by sending the reference number to the first computer;
receive the reference number from the receiver via the second computer;
authorize release of a voucher to the receiver, the voucher only redeemable for one or both of goods and services with the one or more vendors that were selected, the voucher redeemable for an amount corresponding to the value designation, the release authorized based on the reception of the reference number.
